(19) United States
(12) Patent Application Publication
(10) Pub. No.: US 2025/0386086 A1
(43) Pub. Date: Dec. 18, 2025

(54) IMAGING APPARATUS

(71) Applicant: JVCKENWOOD Corporation, Yokohama-shi (JP)

(72) Inventor: Shogo MASUDA, Yokohama-shi (JP)

(21) Appl. No.: 19/314,328

(22) Filed: Aug. 29, 2025

Related U.S. Application Data
(63) Continuation of application No. PCT/JP2024/003999, filed on Feb. 7, 2024.

(30) Foreign Application Priority Data
Mar. 9, 2023 (JP) 2023-036632

(51) Int. Cl. H04N 23/45; H04N 23/55

(52) U.S. Cl. CPC H04N 23/45; H04N 23/55

(57) ABSTRACT

An imaging apparatus includes: a light splitting element that includes a first splitting surface adapted to split an incident light into a first reflected light and a first transmitted light and a second splitting surface adapted to split the first transmitted light into a second reflected light and a second transmitted light; a first sensor that images the first reflected light; a second sensor that images the second reflected light; and a third sensor that images the second transmitted light. The first splitting surface is configured to partially transmit a first wavelength with a first transmittance, partially reflect the first wavelength with a first reflectivity, and transmit a second wavelength with a second transmittance. The second splitting surface is configured to transmit one of the first wavelength and the second wavelength and reflect the other of the first wavelength and the second wavelength.

### CROSS REFERENCE TO RELATED APPLICATION

This application is a continuation of application No. PCT/JP2024/003999, filed on Feb. 7, 2024, and claims the benefit of priority from the prior Japanese Patent Application No. 2023-036632, filed on Mar. 9, 2023, the entire content of which is incorporated herein by reference.

### BACKGROUND

### 1. Technical Field

The present disclosure relates to an imaging apparatus.

### 2. Description of the Related Art

A configuration using a multi-plate prism is known as a multi-plate imaging apparatus configured to capture a common incident light with a plurality of sensors. For example, a configuration in which each of a visible light and an infrared light is imaged by using a spectroscopic prism is known (see, for example, Patent Literature 1).
[Patent Literature 1] JP2021-044790A

In certain applications, two sensors that image light of the first wavelength and one sensor that images light of the second wavelength may be used in combination. When the wavelength is separated by configuring the first splitting surface of a three-plate prism as a dichroic mirror, there is a restriction that requires a sensor that captures the second wavelength be placed on the exit surface of the first prism. When the wavelength is separated by configuring the first splitting surface of the three-plate prism as a half mirror and configuring the second splitting surface as a dichroic mirror, a sensor that captures the second wavelength can be placed on the exit surface of the second prism or the third prism. However, the intensity of light at the second wavelength is reduced to half as a result of transmission through the half mirror of the first splitting surface.

### SUMMARY

An imaging apparatus according to an embodiment of the present disclosure includes: a light splitting element that includes a first splitting surface adapted to split an incident light into a first reflected light and a first transmitted light and a second splitting surface adapted to split the first transmitted light into a second reflected light and a second transmitted light; a first sensor that images the first reflected light; a second sensor that images the second reflected light; and a third sensor that images the second transmitted light. The first splitting surface is configured to partially transmit a first wavelength with a first transmittance, partially reflect the first wavelength with a first reflectivity, and transmit a second wavelength different from the first wavelength with a second transmittance having a larger value than both the first transmittance and the first reflectivity. The second splitting surface is configured to transmit one of the first wavelength and the second wavelength and reflect the other of the first wavelength and the second wavelength.

Optional combinations of the aforementioned constituting elements, and mutual substitution of constituting elements and implementations of the present disclosure between methods, apparatuses, systems, etc. may also be practiced as additional modes of the present disclosure.

### BRIEF DESCRIPTION OF THE DRAWINGS

FIG. 1 schematically shows a configuration of an imaging apparatus according to the embodiment;

FIG. 2 is a table showing exemplary optical characteristics of the imaging apparatus according to the embodiment and the comparative example;

FIG. 3 is a graph schematically showing the wavelength characteristics of a first splitting surface and a second splitting surface according to the first exemplary embodiment;

FIG. 4 is a graph schematically showing the wavelength characteristics of a first splitting surface and a second splitting surface according to the second exemplary embodiment;

FIG. 5 is a graph schematically showing the wavelength characteristics of a first splitting surface and a second splitting surface according to the third exemplary embodiment; and

FIG. 6 is a graph schematically showing the wavelength characteristics of a first splitting surface and a second splitting surface according to the fourth exemplary embodiment.

### DETAILED DESCRIPTION

The invention will now be described by reference to the preferred embodiments. This does not intend to limit the scope of the present invention, but to exemplify the invention.

A description will be given below of embodiments of the present disclosure with reference to the drawings. Specific numerical values shown in the embodiments are by way of example only to facilitate the understanding of the invention and should not be construed as limiting the disclosure unless specifically indicated as such. Those elements in the drawings not directly relevant to the present disclosure are omitted from the illustration.

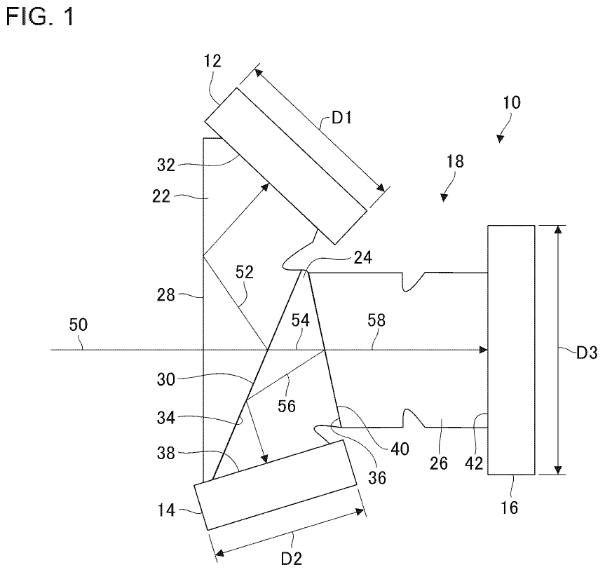

FIG. 1 schematically shows a configuration of an imaging apparatus 10 according to the embodiment. The imaging apparatus 10 includes a first sensor 12, a second sensor 14, a third sensor 16, and a light splitting element 18. The imaging apparatus 10 is a so-called three-plate camera and is configured to split an incident light 50 using the light splitting element 18 and capture an image with each of the first sensor 12, the second sensor 14, and the third sensor 16.

The light splitting element 18 includes a first prism 22, a second prism 24, and a third prism 26. The light splitting element 18 is a so-called three-plate prism. The first prism 22 includes a first incidence surface 28, a first splitting surface 30, and a first exit surface 32. The second prism 24 includes a second incidence surface 34, a second splitting surface 36, and a second exit surface 38. The third prism 26 includes a third incidence surface 40 and a third exit surface 42. An air gap is provided between the first splitting surface 30 and the second incidence surface 34.

The incident light 50 incident on the first incidence surface 28 is split into a first reflected light 52 and a first transmitted light 54 by the first splitting surface 30. The first reflected light 52 reflected by the first splitting surface 30 is totally reflected internally by the first incidence surface 28 and is then transmitted through the first exit surface 32 to travel toward the first sensor 12. The first transmitted light 54 transmitted through the first splitting surface 30 is split into a second reflected light 56 and a second transmitted light 58 by the second splitting surface 36. The second reflected light 56 reflected by the second splitting surface 36 is totally reflected internally by the second incidence surface 34 and is then transmitted through the second exit surface 38 to travel toward the second sensor 14. The second transmitted light 58 transmitted through the second splitting surface 36 is transmitted through the third incidence surface 40 and the third exit surface 42 to travel toward the third sensor 16.

The first sensor 12 is a sensor that captures the first wavelength. One of the second sensor 14 and the third sensor 16 is a sensor that captures the first wavelength. The other of the second sensor 14 and the third sensor 16 is a sensor that captures the second wavelength different from the first wavelength. Thus, two of the first sensor 12, the second sensor 14, and the third sensor 16 are sensors that capture the first wavelength, and the remaining one of the first sensor 12, the second sensor 14, and the third sensor 16 is a sensor that captures the second wavelength.

The first wavelength represents, for example, visible light, and the second wavelength represents, for example, infrared light. The first wavelength may represent infrared light, and the second wavelength may represent visible light. The specific wavelength of the first wavelength and the second wavelength is not particularly limited, and any wavelength in the wavelength range from ultraviolet light to infrared light can be selected. Further, at least one of the first wavelength and the second wavelength may have a predetermined wavelength range. In the case that the first wavelength or the second wavelength represents visible light, for example, the first wavelength or the second wavelength may mean a part or the entirety of the visible wavelength range from red to blue.

The first sensor 12, the second sensor 14, and the third sensor 16 are visible light sensors that capture visible light or infrared light sensors that capture infrared light. Each of the visible light sensor and the infrared light sensor includes an imaging element including a plurality of pixels. A two-dimensional image sensor such as a CCD (Charge Coupled Device) and a CMOS (Complementary Metal Oxide Semiconductor) can be used as the imaging element.

The visible light sensor may be a color image sensor in which red (R), green (G), and blue (B) color filters are provided for each pixel. The visible light sensor may be a polarization sensor in which a plurality of types of polarizers having different polarization directions are provided for each pixel. The visible light sensor may be an event-based vision sensor (EVS) that outputs an image in which only those pixels for which a brightness change is detected are extracted. The infrared light sensor may be a thermal image sensor for capturing a thermal image. The infrared light sensor may be a distance image sensor that measures a distance to an object according to the ToF (Time of Flight) scheme.

The first splitting surface 30 is configured to partially transmit and reflect the first wavelength and entirely transmit the second wavelength different from the first wavelength. In other words, the first splitting surface 30 has partial transparency and partial reflectiveness for the first wavelength and total transparency for the second wavelength. The first splitting surface 30 is configured to be a half mirror with respect to the first wavelength and substantially total transparent (i.e., non-reflective) with respect to the second wavelength. Each of the first transmittance T1 and the first reflectivity R1 at the first wavelength on the first splitting surface 30 is set within a range between a predetermined lower limit value (e.g., 30%, 35%, 40%, or 45%) to a predetermined upper limit value (e.g., 70%, 65%, 60%, or 55%) and is preferably 40% or more and 50% or less. The second transmittance T2 at the second wavelength on the first splitting surface 30 is larger than the first transmittance T1 and the first reflectivity R1 at the first wavelength on the first splitting surface 30 and is larger than a predetermined upper limit value (e.g., 70%). The second transmittance T2 at the second wavelength on the first splitting surface 30 is, for example, 90% or more and preferably 95% or more.

The second splitting surface 36 is configured to entirely transmit one of the first wavelength and the second wavelength and to entirely reflect the other of the first wavelength and the second wavelength. In other words, the second splitting surface 36 has total transparency for one of the first wavelength and the second wavelength and total reflectiveness for the other of the first wavelength and the second wavelength. The second splitting surface 36 is a so-called dichroic mirror, which selectively transmits one of the first wavelength and the second wavelength and selectively reflects the other. The transmittance at one of the first wavelength and the second wavelength on the second splitting surface 36 is larger than the first transmittance T1 and the first reflectivity R1 at the first wavelength on the first splitting surface 30 and is larger than a predetermined upper limit value (e.g., 70%). The transmittance at one of the first wavelength and the second wavelength on the second splitting surface 36 is, for example, 90% or more and preferably 95% or more. The reflectivity at the other of the first wavelength and the second wavelength on the second splitting surface 36 is larger than the first transmittance T1 and the first reflectivity R1 at the first wavelength on the first splitting surface 30 and is larger than a predetermined upper limit value (e.g., 70%). The reflectivity at the other of the first wavelength and the second wavelength on the second splitting surface 36 is, for example, 90% or more and preferably 95% or more.

Each of the first splitting surface 30 and the second splitting surface 36 can be comprised of, for example, a dielectric multilayer mirror. The first splitting surface 30 and the second splitting surface 36 having the desired wavelength characteristics as described above can be realized by adjusting the refractive index and the thickness of each layer constituting the dielectric multilayer film.

In the three-plate prism as shown in FIG. 1, the installation space allowance varies depending on the position of the sensor. Since the third sensor 16 is arranged at a position that does not interfere with the light splitting element 18, much installation space allowance is available so that a sensor having a relatively large sensor size D3 can be arranged. On the other hand, the second sensor 14 is in close proximity to the third prism 26 and has a small installation space allowance so that only a sensor having a relatively small sensor size D2 can be arranged. The first sensor 12 has more installation space allowance than the second sensor 14, but it is necessary to consider interference with the third prism 26 so that the first sensor 12 has a smaller installation space allowance than the third sensor 16. Therefore, the sensor size D1 that the first sensor 12 can have is larger than the sensor size D2 that the second sensor 14 can have and is smaller than the sensor size D3 that the third sensor 16 can have (i.e., D3>D1>D2).

A description will now be given of the advantage provided by the embodiment with reference to comparative examples.

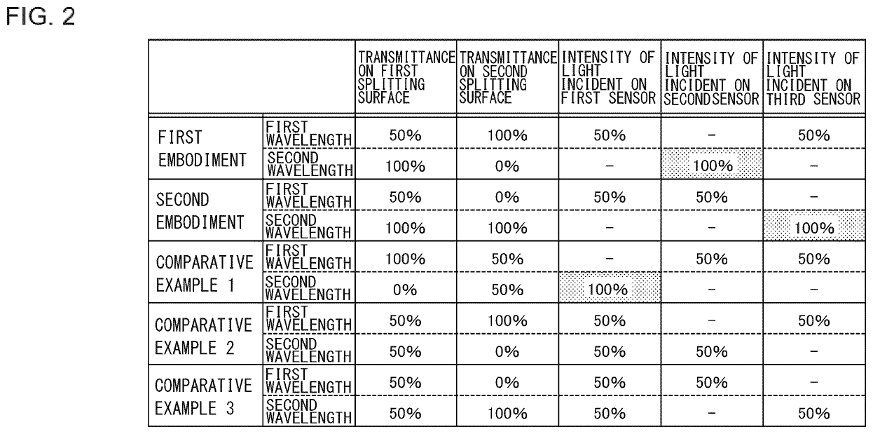

FIG. 2 is a table showing exemplary optical characteristics of the imaging apparatus 10 according to the embodiment and the comparative examples. In the example of FIG. 2, the transmittance in the case of substantially total transmittance (i.e., non-reflection) is defined to be 100%, the transmittance in the case of substantially total reflection (that is, non-transparency) is defined to be 0%, and the transmittance in the case of partial transmittance and reflection is defined to be 50%, for ease of understanding. With regard to the intensity of light incident on each of the first sensor 12, the second sensor 14, and the third sensor 16, the light intensity of the incident light 50 is defined to be 100%, and the light loss due to the passage through the light splitting element 18 is ignored.

In the first embodiment and the second embodiment, the transmittance at the first wavelength on the first splitting surface 30 is 50%, and the transmittance at the second wavelength on the first splitting surface 30 is 100%. In the first embodiment, the transmittance at the first wavelength on the second splitting surface 36 is 100%, and the transmittance at the second wavelength on the second splitting surface 36 is 0%. In the second embodiment, contrary to the first embodiment, the transmittance at the first wavelength on the second splitting surface 36 is 0%, and the transmittance at the second wavelength on the second splitting surface 36 is 100%.

In the first embodiment, the intensity of light at the first wavelength incident on each of the first sensor 12 and the third sensor 16 is 50%, and the intensity of light at the second wavelength incident on the second sensor 14 is 100%. In the first embodiment, therefore, the first sensor 12 and the third sensor 16 are sensors that capture the first wavelength, and the second sensor 14 is a sensor that captures the second wavelength.

In the second embodiment, the intensity of light at the first wavelength incident on each of the first sensor 12 and the second sensor 14 is 50%, and the intensity of light at the second wavelength incident on the third sensor 16 is 100%. In the second embodiment, therefore, the first sensor 12 and the second sensor 14 are sensors that capture the first wavelength, and the third sensor 16 is a sensor that captures the second wavelength.

In the comparative example, a common half mirror and a common dichroic mirror are used in combination in the first splitting surface 30 and the second splitting surface 36.

In comparative example 1, the first splitting surface 30 is a dichroic mirror, and the second splitting surface 36 is a half mirror. In comparative example 1, the transmittance at the first wavelength on the first splitting surface 30 is 100%, and the transmittance at the second wavelength on the first splitting surface 30 is 0%. In comparative example 1, the transmittance at the first wavelength on the second splitting surface 36 is 50%, and the transmittance at the second wavelength on the second splitting surface 36 is 50%.

In comparative example 1, the intensity of light at the first wavelength incident on each of the second sensor 14 and the third sensor 16 is 50%, and the intensity of light at the second wavelength incident on the first sensor 12 is 100%. In comparative example 1, therefore, the second sensor 14 and the third sensor 16 are sensors that capture the first wavelength, and the first sensor 12 is a sensor that captures the second wavelength.

In comparative example 1, the intensity of light at the first wavelength incident on each of the two sensors that capture the first wavelength can be maximized (e.g., to 50%), and the intensity of light at the second wavelength incident on the one sensor that captures the second wavelength can be maximized (e.g., to 100%). In comparative example 1, there is a restriction on arrangement that requires that the sensor for capturing the second wavelength be the first sensor 12.

In comparative example 2 and comparative example 3, the first splitting surface 30 is a half mirror, and the second splitting surface 36 is a dichroic mirror. In comparative example 2 and comparative example 3, the transmittance at the first wavelength on the first splitting surface 30 is 50%, and the transmittance at the second wavelength on the first splitting surface 30 is 50%. In comparative example 2, the transmittance at the first wavelength on the second splitting surface 36 is 100%, and the transmittance at the second wavelength on the second splitting surface 36 is 0%. In comparative example 3, the transmittance at the first wavelength on the second splitting surface 36 is 0%, and the transmittance at the second wavelength on the second splitting surface 36 is 100%.

In comparative example 2, the intensity of light at the first wavelength incident on each of the first sensor 12 and the third sensor 16 is 50%, and the intensity of light at the second wavelength incident on each of the first sensor 12 and the second sensor 14 is 50%. In comparative example 3, the intensity of light at the first wavelength incident on each of the first sensor 12 and the second sensor 14 is 50%, and the intensity of light at the second wavelength incident on each of the first sensor 12 and the third sensor 16 is 50%.

In comparative example 2, the sensor that captures the second wavelength can be the first sensor 12 or the second sensor 14, and, in comparative example 3, the sensor that captures the second wavelength can be the first sensor 12 or the third sensor 16. Therefore, there is little restriction on arrangement. In comparative example 2 and comparative example 3, the intensity of light at the second wavelength incident on the sensor that captures the second wavelength is about 50% so that the intensity of light at the second wavelength incident on the sensor that captures the second wavelength cannot be maximized (e.g., to 100%).

According to the embodiment, on the other hand, the intensity of light at the first wavelength incident on each of the two sensors that capture the first wavelength can be maximized (e.g., to 50%), and the intensity of light at the second wavelength incident on the one sensor that captures the second wavelength can also be maximized (e.g., to 100%), as in comparative example 1. Further, the sensor that captures the second wavelength can be arranged as the second sensor 14 or the third sensor 16 by using either the first embodiment or the second embodiment. According to the embodiments, therefore, the degree of freedom in sensor arrangement can be improved as compared to comparative example 1, and the intensity of light at the first wavelength or the second wavelength incident on the three sensors can be maximized as compared to comparative examples 2-3. According to the embodiments, maximization of the intensity of light incident on the plurality of sensors and the degree of freedom in the arrangement of the plurality of sensors can be achieved at the same time.

In the case of the first embodiment, the sensor that captures the second wavelength is the second sensor 14 so that, for example, it is possible to use large sensors as the two sensors that capture the first wavelength. In the case of the second embodiment, the sensor that captures the second wavelength is the third sensor 16 so that, for example, it is possible to use a large sensor as the sensor that captures the second wavelength.

Hereinafter, exemplary embodiments relating to specific wavelength characteristics of the first splitting surface 30 and the second splitting surface 36 will be described.

### First Exemplary Embodiment

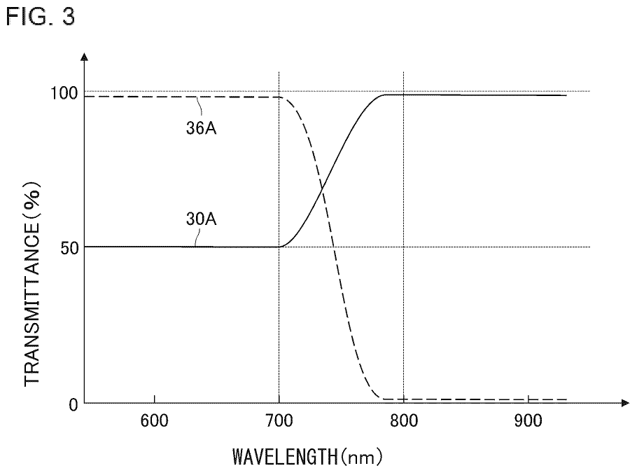

FIG. 3 is a graph schematically showing the wavelength characteristics of a first splitting surface 30A and a second splitting surface 36A according to the first exemplary embodiment. The first exemplary embodiment of FIG. 3 represents a version of the first embodiment described above in which the first wavelength is a visible light wavelength of 700 nm or less and the second wavelength is an infrared light wavelength of 800 nm or more.

On the first splitting surface 30A, the first transmittance at the first wavelength (visible light) is about 50% (e.g., 45%-50%), and the second transmittance at the second wavelength (infrared light) is about 100% (e.g., 95%-100%). On the first splitting surface 30A, the first reflectivity at the first wavelength (visible light) is about 50% (e.g., 45%-50%), and the second reflectivity at the second wavelength (infrared light) is about 0% (e.g., 0%-5%).

On the second splitting surface 36A, the transmittance at the first wavelength (visible light) is about 100% (e.g., 95%-100%), and the transmittance at the second wavelength (infrared light) is about 0% (e.g., 0%-5%). On the second splitting surface 36A, the reflectivity at the first wavelength (visible light) is about 0% (e.g., 0%-5%), and the reflectivity at the second wavelength (infrared light) is about 100% (e.g., 95%-100%).

In the first exemplary embodiment, about 50% of the light intensity of the incident light 50 at the first wavelength (visible light) can be incident on each of the first sensor 12 and the third sensor 16, and about 100% of the light intensity of the incident light 50 at the second wavelength (infrared light) can be incident on the second sensor 14.

In the first exemplary embodiment, the first sensor 12 and the third sensor 16 are visible light sensors, and the second sensor 14 is an infrared light sensor. According to the first exemplary embodiment, the light intensity of visible light incident on each of the first sensor 12 and the third sensor 16 can be maximized, and the light intensity of infrared light incident on the second sensor 14 can be maximized. The first exemplary embodiment is effective when the sensor size of the two visible light sensors is sought to be increased.

According to the first exemplary embodiment, the first sensor 12 can be a color image sensor, the second sensor 14 can be a distance image sensor, and the third sensor 16 can be a polarization sensor or an EVS, for example. The sensor size available to polarization sensors and EVSs may be limited as compared to other sensors, and polarization sensors and EVSs may have a relatively large sensor size. According to the first exemplary embodiment, the third sensor 16 with the largest installation space allowance can be a polarization sensor or an EVS. Further, a distance image sensor may have a smaller number of pixels than other sensors and may have a relatively small sensor size. According to the first exemplary embodiment, the second sensor 14 with the smallest installation space allowance can be a distance image sensor. Thereby, the first sensor 12 with a larger installation space allowance as compared to the second sensor 14 can be a color image sensor. Consequently, a color image sensor with a larger sensor size can be employed as compared to a case where the second sensor 14 is a color image sensor.

### Second Exemplary Embodiment

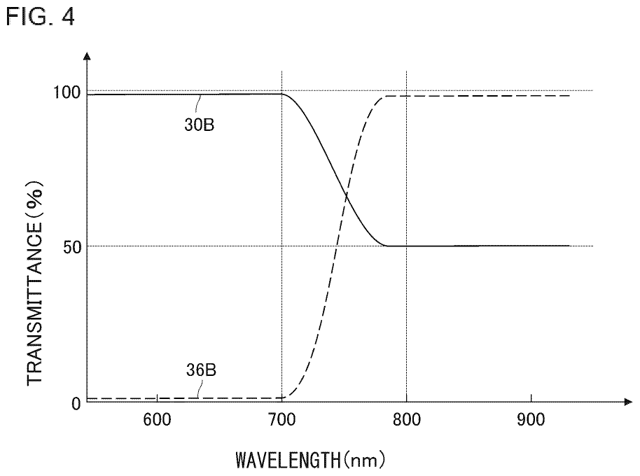

FIG. 4 is a graph schematically showing the wavelength characteristics of a first splitting surface 30B and a second splitting surface 36B according to the second exemplary embodiment. The second exemplary embodiment of FIG. 4 represents a version of the first embodiment described above in which the first wavelength is an infrared light wavelength of 800 nm or more and the second wavelength is a visible light wavelength of 700 nm or less.

On the first splitting surface 30B, the first transmittance at the first wavelength (infrared light) is about 50% (e.g., 45%-50%), and the second transmittance at the second wavelength (visible light) is about 100% (e.g., 95%-100%). On the first splitting surface 30B, the first reflectivity at the first wavelength (infrared light) is about 50% (e.g., 45%-50%), and the second reflectivity at the second wavelength (visible light) is about 0% (e.g., 0%-5%).

On the second splitting surface 36B, the transmittance at the first wavelength (infrared light) is about 100% (e.g., 95%-100%), and the transmittance at the second wavelength (visible light) is about 0% (e.g., 0%-5%). On the second splitting surface 36B, the reflectivity at the first wavelength (infrared light) is about 0% (e.g., 0%-5%), and the reflectivity at the second wavelength (visible light) is about 100% (e.g., 95%-100%).

In the second exemplary embodiment, about 50% of the light intensity of the incident light 50 at the first wavelength (infrared light) can be incident on each of the first sensor 12 and the third sensor 16, and about 100% of the light intensity of the incident light 50 at the second wavelength (visible light) can be incident on the second sensor 14.

In the second exemplary embodiment, the first sensor 12 and the third sensor 16 are infrared light sensors, and the second sensor 14 is a visible light sensor. According to the second exemplary embodiment, the light intensity of infrared light incident on each of the first sensor 12 and the third sensor 16 can be maximized, and the light intensity of visible light incident on the second sensor 14 can be maximized. The second exemplary embodiment is effective when the size of the two infrared light sensors is sought to be increased as much as possible. In the second exemplary embodiment, the first sensor 12 can be a distance image sensor, the second sensor 14 can be a color image sensor, and the third sensor can be a thermal image sensor, for example.

### Third Exemplary Embodiment

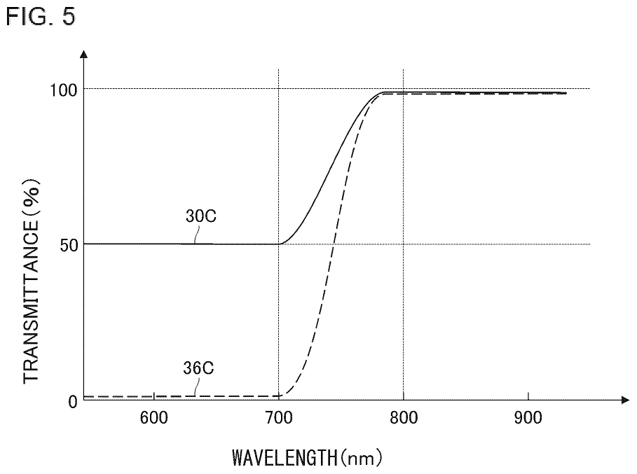

FIG. 5 is a graph schematically showing the wavelength characteristics of a first splitting surface 30C and a second splitting surface 36C according to the third exemplary embodiment. The third exemplary embodiment of FIG. 5 represents a version of the second embodiment described above in which the first wavelength is a visible light wavelength of 700 nm or less and the second wavelength is an infrared light wavelength of 800 nm or more.

The first splitting surface 30C is the same as the first splitting surface 30A according to the first embodiment. On the first splitting surface 30C, the first transmittance at the first wavelength (visible light) is about 50% (e.g., 45%-50%), and the second transmittance at the second wavelength (infrared light) is about 100% (e.g., 95%-100%). On the first splitting surface 30C, the first reflectivity at the first wavelength (visible light) is about 50% (e.g., 45%-50%), and the second reflectivity at the second wavelength (infrared light) is about 0% (e.g., 0%-5%).

The second splitting surface 36C represents a version of the second splitting surface 36A according to the first embodiment in which the reflectivity and the transmittance are inverted. On the second splitting surface 36C, the transmittance at the first wavelength (visible light) is about 0% (e.g., 0%-5%), and the transmittance at the second wavelength (infrared light) is about 100% (e.g., 95%-100%). On the second splitting surface 36C, the reflectivity at the first wavelength (visible light) is about 100% (e.g., 95%-100%), and the reflectivity at the second wavelength (infrared light) is about 0% (e.g., 0%-5%).

In the third exemplary embodiment, about 50% of the light intensity of the incident light 50 at the first wavelength (visible light) can be incident on each of the first sensor 12 and the second sensor 14, and about 100% of the light intensity of the incident light 50 at the second wavelength (infrared light) can be incident on the third sensor 16.

In the third exemplary embodiment, the first sensor 12 and the second sensor 14 are visible light sensors, and the third sensor 16 is an infrared light sensor. According to the third exemplary embodiment, the light intensity of visible light incident on each of the first sensor 12 and the second sensor 14 can be maximized, and the light intensity of infrared light incident on the third sensor 16 can be maximized. The third exemplary embodiment is effective when the size of the one infrared light sensor is sought to be increased as much as possible. In the third exemplary embodiment, the first sensor 12 can be a polarization sensor or an EVS, the second sensor 14 can be a color image sensor, and the third sensor can be a thermal image sensor or a distance image sensor, for example.

### Fourth Exemplary Embodiment

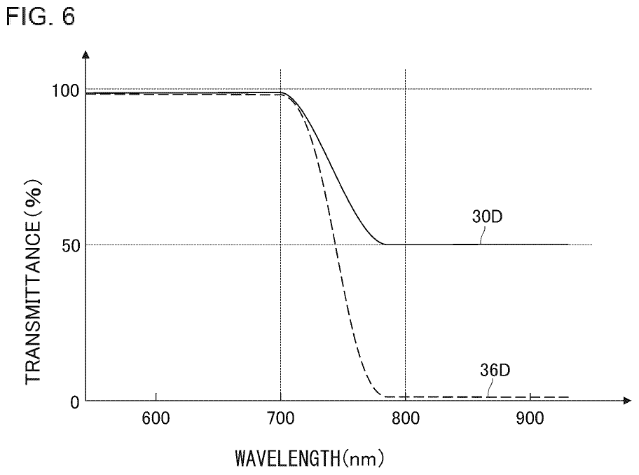

FIG. 6 is a graph schematically showing the wavelength characteristics of a first splitting surface 30D and a second splitting surface 36D according to the fourth exemplary embodiment. The fourth exemplary embodiment of FIG. 6 represents a version of the second embodiment described above in which the first wavelength is an infrared light wavelength of 800 nm or more and the second wavelength is a visible light wavelength of 700 nm or less.

The first splitting surface 30D is the same as the first splitting surface 30B according to the second embodiment. On the first splitting surface 30D, the first transmittance at the first wavelength (infrared light) is about 50% (e.g., 45%-50%), and the second transmittance at the second wavelength (visible light) is about 100% (e.g., 95%-100%). On the first splitting surface 30D, the first reflectivity at the first wavelength (infrared light) is about 50% (e.g., 45%-50%), and the second reflectivity at the second wavelength (visible light) is about 0% (e.g., 0%-5%).

The second splitting surface 36D represents a version of the second splitting surface 36C according to the third embodiment in which the reflectivity and the transmittance are inverted. On the second splitting surface 36D, the transmittance at the first wavelength (infrared light) is about 0% (e.g., 0%-5%), and the transmittance at the second wavelength (visible light) is about 100% (e.g., 95%-100%). On the second splitting surface 36D, the reflectivity at the first wavelength (infrared light) is about 100% (e.g., 95%-100%), and the reflectivity at the second wavelength (visible light) is about 0% (e.g., 0%-5%).

In the fourth exemplary embodiment, about 50% of the light intensity of the incident light 50 at the first wavelength (infrared light) can be incident on each of the first sensor 12 and the second sensor 14, and about 100% of the light intensity of the incident light 50 at the second wavelength (visible light) can be incident on the third sensor 16.

In the fourth exemplary embodiment, the first sensor 12 and the second sensor 14 are infrared light sensors, and the third sensor 16 is a visible light sensor. According to the fourth exemplary embodiment, the light intensity of infrared light incident on each of the first sensor 12 and the second sensor 14 can be maximized, and the light intensity of visible light incident on the third sensor 16 can be maximized. The fourth exemplary embodiment is effective when the size of the one visible light sensor is sought to be increased as much as possible. In the fourth exemplary embodiment, the first sensor 12 can be a thermal image sensor, the second sensor 14 can be a distance image sensor, and the third sensor can be a color image sensor, a polarization sensor, or an EVS.

According to the present disclosure, maximization of the intensity of light incident on the plurality of sensors and the degree of freedom in the arrangement of the plurality of sensors can be achieved at the same time.

The present disclosure has been explained with reference to the embodiments described above, but the present disclosure is not limited to the embodiments described above, and appropriate combinations or replacements of the features shown in the examples presented are also encompassed by the present disclosure.

What is claimed is:

1. An imaging apparatus comprising:
a light splitting element that includes a first splitting surface adapted to split an incident light into a first reflected light and a first transmitted light and a second splitting surface adapted to split the first transmitted light into a second reflected light and a second transmitted light;
a first sensor that images the first reflected light;
a second sensor that images the second reflected light; and
a third sensor that images the second transmitted light,
wherein the first splitting surface is configured to partially transmit a first wavelength with a first transmittance, partially reflect the first wavelength with a first reflectivity, and transmit a second wavelength different from the first wavelength with a second transmittance having a larger value than both the first transmittance and the first reflectivity, and
wherein the second splitting surface is configured to transmit one of the first wavelength and the second wavelength and reflect the other of the first wavelength and the second wavelength.

2. The imaging apparatus according to claim 1,
wherein the first splitting surface is configured to selectively transmit the second wavelength.

3. The imaging apparatus according to claim 1,
wherein a size of the third sensor is larger than a size of the second sensor.

4. The imaging apparatus according to claim 1,
wherein the second splitting surface is a dichroic mirror that selectively transmits a visible light wavelength and selectively reflects an infrared light wavelength, and
wherein the second sensor is an infrared light sensor, and the third sensor is a visible light sensor.

5. The imaging apparatus according to claim 1,
wherein the second splitting surface is a dichroic mirror that selectively reflects a visible light wavelength and selectively transmits an infrared light wavelength, and
wherein the second sensor is a visible light sensor, and the third sensor is an infrared light sensor.
